(19) United States
(12) Patent Application Publication
(10) Pub. No.: US 2005/0222839 A1
(43) Pub. Date: Oct. 6, 2005

(54) Multilingual software installation system and method

(76) Inventor: Tzu-Pei Chen, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/899,330

(22) Filed: Jul. 26, 2004

(30) Foreign Application Priority Data
Apr. 5, 2004 (TW) 93109333

(51) Int. Cl. G06F 17/20; G06F 17/28

(52) U.S. Cl. 704/8; 704/2; 704/7

(57) ABSTRACT

A multilingual software installation system and method. The system includes a multilingual text file and a setup module. The multilingual text file is constructed with sections and index directives, including at least a first tier section, a second tier section and a third tier section. During software installation, the setup module retrieves an environment language family code and an environment language code of a setup environment, searches for a language family in the first tier section according to the environment language family code, searches for a language type in the second tier section corresponding to the language family according to the environment language code, and retrieves sentences/data from the third tier section corresponding to the language type.

### BACKGROUND

The invention relates to multilingual software installation, and particularly to a multilingual software installation system and method that installs software with a specific language using a multilingual text file.

For software products, including device drivers and applications, a convenient setup program is required. If the software products must provide multilingual user applications, software developers have to buy multiple language packages to extend the setup program to a setup package supporting other specific languages excluding the default language, English. Additionally, the size of the setup package will be enlarged by 3 or 4 times due to the additional language resources.

FIG. 1 is a schematic diagram illustrating a software package providing multilingual user applications. As shown in FIG. 1, if the software package 100 provides the multilingual user applications in English, Traditional Chinese, Simplified Chinese, and Japanese, the developer must merge multiple language resources, such as English language resource 110, traditional Chinese language resource 120, simplified Chinese language resource 130, and Japanese language resource 140 to the software package 100 to generate a multilingual package. In general, each language resource requires 1000 K byte. If a software package supports more than twenty languages, the size of the setup package will be 25-28 mega bytes. The setup package will occupy an excessive amount of space in a storage medium. If the setup package is downloaded via Internet, the data transmission is time-consuming.

From a developer perspective, since only a small portion of a language resource is used by the software, the cost for overall language resources is high. Additionally, the language expansibility of the software package is limited to the supported language resources, and it is difficult to change the content in the language resources since the language resources are provided from other companies.

### SUMMARY

According to an embodiment of the invention, a multilingual software installation system is provided. The system includes a multilingual text file and a setup module. The multilingual text file is constructed with sections and index directives, including at least a first tier section, a second tier section and a third tier section. The setup module installs software in a setup environment. When the setup module installs software, the setup module retrieves an environment language family code and an environment language code of the setup environment, searches for a language family in the first tier section according to the environment language family code, searches for a language type in the second tier section corresponding to the language family according to the environment language code, and retrieves data from the third tier section corresponding to the language type.

The setup module further retrieves at least one sentence complying with a sentence code from the third tier section corresponding to the language type, and displays the sentence to help software installation.

Embodiments of the invention further provide a multilingual software installation method. First, an environment language family code and an environment language code of a setup environment are retrieved. Then, a language family is searched for in a first tier section of a multilingual text file according to the environment language family code, and a language type is searched for in a second tier section corresponding to the language family of the multilingual text file according to the environment language code. Thereafter, data is retrieved from a third tier section corresponding to the language type of the multilingual text file.

At least one sentence complying with a sentence code is further retrieved from the third tier section corresponding to the language type of the multilingual text file, and the sentence is displayed to help software installation.

The above-mentioned method and system may take the form of program code embodied in a tangible media. When the program code is loaded into and executed by a machine, the machine can become an apparatus for practicing the disclosed methods.

### BRIEF DESCRIPTION OF THE DRAWINGS

The aforementioned features and advantages will become apparent by referring to the following detailed description with reference to the accompanying drawings, wherein:

FIG. 1 is a schematic diagram illustrating a software package providing multilingual user applications;

FIG. 2 is a schematic diagram illustrating the architecture of the multilingual software installation system according to an embodiment of the invention;

FIG. 3 is a schematic diagram illustrating the components of a multilingual software package according to an embodiment of the invention;

FIG. 4 shows an example of a multilingual text file;

FIG. 5 is a flowchart showing the multilingual software installation method according to an embodiment of the invention; and

FIG. 6 is a schematic diagram illustrating a storage medium storing a computer program for execution of the multilingual software installation method according to an embodiment of the invention.

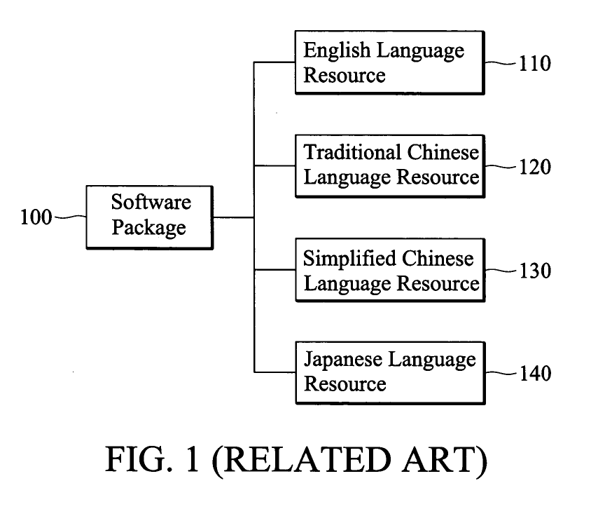

### DETAILED DESCRIPTION

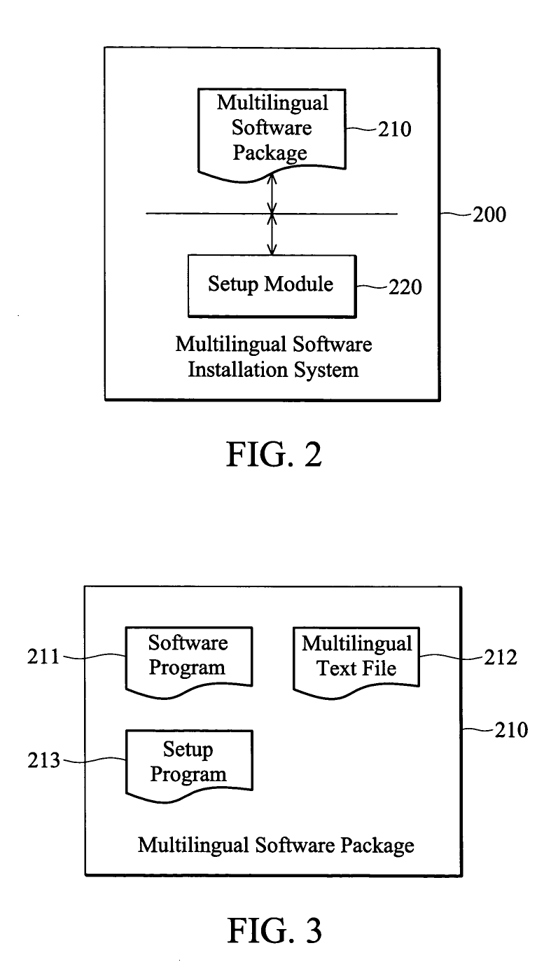

FIG. 2 is a schematic diagram illustrating the architecture of the multilingual software installation system according to an embodiment of the invention.

The multilingual software installation system 200 according to an embodiment of the invention includes a multilingual software package 210 and a setup module 220. The multilingual software package 210 comprises software 211, a multilingual text file 212, and a setup program 213 as shown in FIG. 3. It is understood that the multilingual software package 210 may be downloaded from a network to a system desiring installation of the software 211. The software 211 may be multilingual software, supporting related operations in different language versions. If the software 211 is ready, the setup module 220 executes the setup program 213 to install the software 211 with a specific language version to the computer system. Related operations are discussed later.

The multilingual text file 212 is constructed with sections and index directives. The multilingual text file 212 has a tier structure, including a first tier section, a second tier section and a third tier section. The first tier section is denominated as [MULTI_LANG]. Language family codes and language families corresponding to the respective language family codes are recorded in the first tier section. Language codes in the respective language families and language types corresponding to the respective language codes are recorded in the second tier section. The naming rule of the second tier section is [{Language Family Name}_FAMILY]. Sentence codes in the respective language types and sentences corresponding to the respective sentence codes are recorded in the third tier section. The naming rule of the third tier section is [{Language Name}].

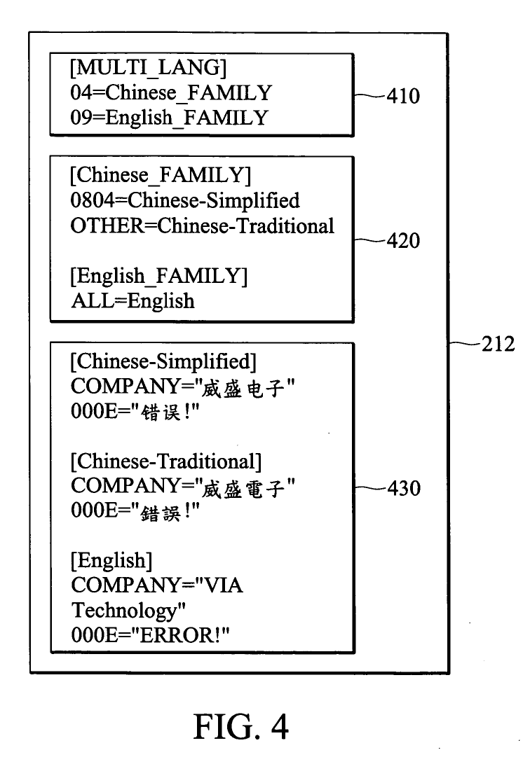

FIG. 4 shows an example of a multilingual text file. In this example, the multilingual text file 212 supports three languages, simplified Chinese, traditional Chinese, and English. In the first tier 410, different language families and corresponding language family codes are recorded. For example, a language family code “04” indicates the Chinese family, and a language family code “09” indicates the English family. In the second tier 420, different language types in the respective language families and language type codes are recorded. For example, the section [Chinese_FAMILY] includes a language type code “0804” indicates the simplified Chinese, and a language type code “OTHER” indicates the traditional Chinese. Further, the section [English_FAMILY] includes a language type code “ALL” indicates the English. In the third tier 430, sentences corresponding to different sentence codes in the respective language types are recorded. It is understood that, in FIG. 4, the sentence codes may be any strings or symbols, and the sentences in the quotation marks in respective language types may be text or specific codes recognized by the corresponding languages or computer systems. In this example, the sentences with the same sentence code in different language type sections have the same meaning, but in different language wording. For example, the sentences corresponding to the sentence code “COMPANY”, simplified Chinese characters “z,900 z,901 z,902 z,903”, traditional Chinese characters “z,900 z,901 z,904 z,903” and English “VIA Technology” have the same meaning during software installation. Furthermore, the sentences corresponding to the sentence code “000E”, simplified Chinese characters “z,905 z,906 !”, traditional Chinese characters “z,907 z,908 !”, and English characters “ERROR!” have the same meaning during software installation.

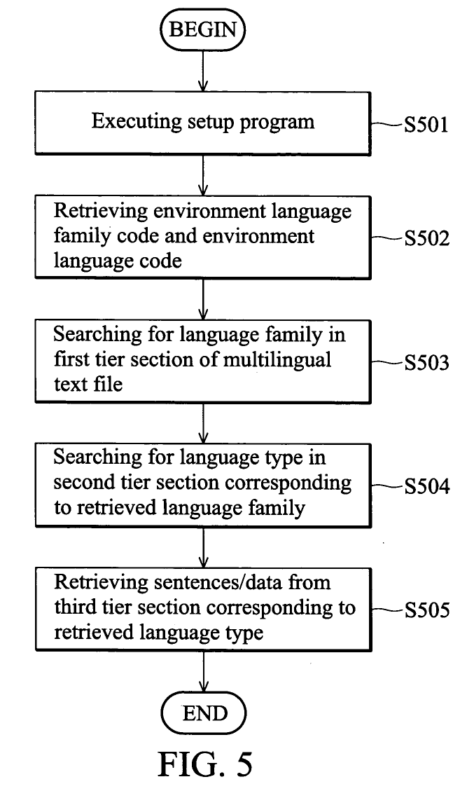

FIG. 5 is a flowchart showing the multilingual software installation method according to an embodiment of the invention.

When the setup module 220 installs the software 211, in step S501, the setup program 213 is executed. In step S502, an environment language family code and an environment language code of a setup environment are retrieved by an operating system of a computer system. Then, in step S503, a language family is searched for in the first tier section of the multilingual text file 212 according to the environment language family code, and in step S504, a language type is searched for in the second tier section corresponding to the retrieved language family of the multilingual text file 212 according to the environment language code. Thereafter, in step S505, sentences/data are retrieved from the third tier section corresponding to the retrieved language type of the multilingual text file 212. It is understood that the setup program 213 automatically generates sentence codes according to a predetermined procedure during software installation, and the setup module 220 retrieves sentences complying with the codes from the third tier section corresponding to the retrieved language type of the multilingual text file 212, and displays the sentences in order, to facilitate software installation.

It is also understood that the setup module 220 may determine whether the environment language code needs to be reset when the environment language code has been retrieved. For example, if the environment language family code corresponds to the Chinese family, and the retrieved environment language code is not the code for simplified Chinese, the setup module 220 can set the environment language code as “OTHER”. Additionally, if the environment language family code corresponds to the English family, the environment language code is set as “ALL”, no matter what the retrieved environment language code is.

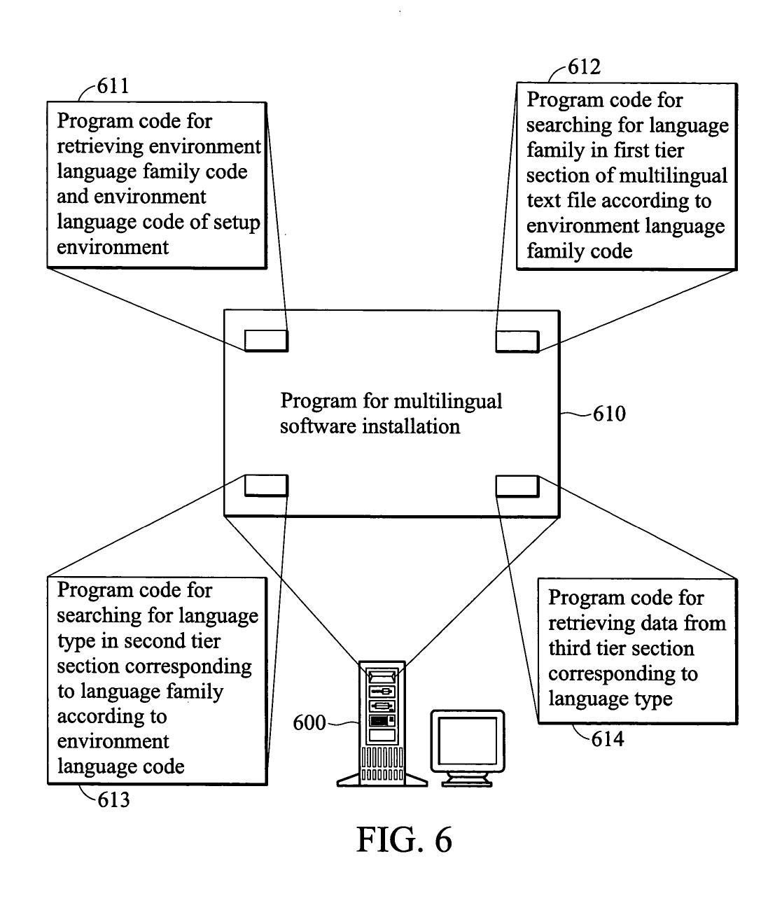

FIG. 6 is a diagram of a storage medium storing a computer program providing the multilingual software installation method according to an embodiment of the invention. The computer program product comprises a storage medium 610 having computer readable program code embodied therein for use in a computer system 600. The computer readable program code comprises at least computer readable program code 611 retrieving an environment language family code and an environment language code of a setup environment, computer readable program code 612 searching for a language family in a first tier section of a multilingual text file according to the environment language family code, computer readable program code 613 searching for a language type in a second tier section corresponding to the language family of the multilingual text file according to the environment language code, and computer readable program code 614 retrieving sentences/data from a third tier section corresponding to the language type of the multilingual text file.

Embodiments of the invention provide a multilingual software installation system and method that installs software with a specific language using a multilingual text file with a particular format and structure, thereby reducing cost for software development. Since a single text file can be used to support multilingual software installation, the size of software packages can be reduced, thus speeding up the download transmission and installation of software. Furthermore, if information or contents during software installation require to be updated, it is convenient to amend the text file.

Embodiments of the system and method, or certain aspects or portions thereof, may take the form of program code (i.e., executable instructions) embodied in tangible media, such as products, floppy diskettes, CD-ROMS, hard drives, or any other machine-readable storage medium, wherein, when the program code is loaded into and executed by a machine, such as a computer, the machine thereby becomes an apparatus for practicing the embodiment. The method and system may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed embodiment. When implemented on a general-purpose processor, the program code combines with the processor to provide a unique apparatus that operates analogously to application specific logic circuits.

Although the present invention has been described in its preferred embodiments, it is not intended to limit the invention to the precise embodiments disclosed herein. Those who are skilled in this technology can still make various alterations and modifications without departing from the scope and spirit of this invention. Therefore, the scope of the present invention shall be defined and protected by the following claims and their equivalents.

1. A multilingual software installation system, comprising:
a multilingual text file comprising sections and index directives, including at least a first tier section, a second tier section and a third tier section; and
a setup module installing software in a setup environment, during software installation, to retrieve an environment language family code and an environment language code of the setup environment, search for a language family in the first tier section of the multilingual text file according to the environment language family code, search for a language type in the second tier section corresponding to the language family according to the environment language code, and retrieve data from the third tier section corresponding to the language type.

2. The system of claim 1 wherein the setup module further retrieves at least one sentence complying with a sentence code from the third tier section corresponding to the language type.

3. The system of claim 2 wherein the setup module further displays the retrieved sentence to facilitate software installation.

4. A multilingual software installation method to install software with a multilingual text file in a setup environment, comprising the steps of:
retrieving an environment language family code and an environment language code of the setup environment;
searching for a language family in a first tier section of the multilingual text file according to the environment language family code;
searching for a language type in a second tier section corresponding to the language family of the multilingual text file according to the environment language code; and
retrieving data from a third tier section corresponding to the language type of the multilingual text file.

5. The method of claim 4 further comprising retrieving at least one sentence complying with a sentence code from the third tier section corresponding to the language type.

6. The method of claim 5 further comprising displaying the retrieved sentence to facilitate software installation.

7. The method of claim 4 wherein the multilingual text file is constructed with sections and index directives.

8. A machine-readable storage medium storing a computer program, causing when executed a computer to perform a multilingual software installation method to install software in a setup environment, the method comprising:
retrieving an environment language family code and an environment language code of the setup environment;
searching for a language family in a first tier section of a multilingual text file according to the environment language family code;
searching for a language type in a second tier section corresponding to the language family of the multilingual text file according to the environment language code; and
retrieving data from a third tier section corresponding to the language type of the multilingual text file.

9. The storage medium of claim 8, the method further comprising retrieving at least one sentence complying with a sentence code from the third tier section corresponding to the language type.

10. The storage medium of claim 9, the method further comprising displaying the retrieved sentence to facilitate software installation.

11. The storage medium of claim 8 wherein the multilingual text file is constructed with sections and index directives.

12. A multilingual software installation product, comprising:
at least one software program;
a setup program; and
a multilingual text file constructed with sections and index directives, including at least a first tier section, a second tier section and a third tier section, at least one language family code and a language family corresponding to the language family code are recorded in the first tier section, at least one language code in the language family and a language type corresponding to the language codes are recorded in the second tier section, and data in the language type is recorded in the third tier section;
when the setup program installs the software in a setup environment, and an environment language family code and an environment language code of the setup environment comply with the language family code and the language code respectively recorded in the first tier section and the second tier section of the multilingual text file, the data is retrieved from the third tier section corresponding to the language type.

13. The product of claim 12 wherein the setup program further retrieves at least one sentence complying with a sentence code from the third tier section corresponding to the language type during software installation.

14. The product of claim 13 wherein the setup program further displays the retrieved sentence to help software installation.
